(19) United States
(12) Patent Application Publication
(10) Pub. No.: US 2013/0145796 A1
(43) Pub. Date: Jun. 13, 2013

(54) CUTTING DEVICE AND METHOD FOR PRODUCING FOAM GLASS BOARDS

(71) Applicant: Walter Frank, Weiden (DE)

(72) Inventor: Walter Frank, Weiden (DE)

(21) Appl. No.: 13/809,317

(22) PCT Filed: Jul. 8, 2011
(86) PCT No.: PCT/EP2011/061708

§ 371 Date: Feb. 26, 2013

(30) Foreign Application Priority Data
Jul. 9, 2010 (DE) 10 2010 036 319.7

(51) Int. Cl. C03B 35/14; C03B 33/023

(52) U.S. Cl. CPC C03B 35/14; C03B 33/023
USPC 65/22; 65/346; 83/284

(57) ABSTRACT

The present invention relates to a method for the continuous production of cellular glass sheets, wherein the cellular glass is expanded from at least one glass raw material and at least one blowing agent in a cellulating furnace to yield a cellular glass web (16) and is then continuously cooled in a cooling furnace (5), wherein the cellular glass web is transported on a continuous conveyor system through the furnace(s) during foaming and cooling, and wherein the cellular glass web is cut in the furnace or between two furnaces as well as a corresponding cutting apparatus and a cellular-glass cooling section with a corresponding cutting apparatus.

### BACKGROUND OF THE INVENTION

1. Field of the Invention

The invention relates to a method for the continuous production of cellular glass sheets, wherein the cellular glass is expanded from at least one glass raw material and at least one blowing agent in a cellulating furnace to yield a cellular glass web and is continuously cooled in a cooling furnace, wherein the cellular glass web is transported on a continuous conveyor system through the furnace(s) during foaming and cooling, and in particular to a cutting device for cutting a continuously moving object transverse to the direction of movement, especially the cellular glass web on the continuous conveyor system, as well as to a cellular-glass cooling section with a cooling furnace in particular for implementing the method for the continuous production of cellular glass sheets.

2. State of the Art

DE 10 2004 040 307 A1 discloses an apparatus and a method for the continuous production of one-piece cellular glass sheets, whereby the cellular glass is formed from glass particles and a blowing agent with a thermal treatment to give an endless cellular glass web and, directly after expansion, the cellular glass web is continuously cooled at such a rate that the cellular glass has a stress-free structure made up of glass and a number of pores. A lateral cross-sectional view of a corresponding apparatus is shown in FIG. 4.

In FIG. 4, it can be seen that, after the raw materials for producing the cellular glass have been fed into a hopper 1, the cellular glass web 15 is expanded in a cellulating furnace 4, with the cellular glass web 15 being moved through the cellulating furnace 4 on an endless conveyor belt 3. Directly adjacent to the furnace is a cooling furnace 5, which also comprises one or more endless conveyor devices 7, 8 in the form of rotating conveyor belts, wire mesh belts, or the like, so that the cellular glass web 15 which has been expanded in the cellulating furnace 4 is continuously advanced. By means of appropriate heating and cooling devices 6, the cellular glass web 15 is slowly cooled to room temperature to form a solidified cellular glass web 16 having a plurality of pores. Outside of the cooling furnace 5 and at the end of the apparatus are provided two cutting devices 9 and 10, which allow cutting of the cellular glass web both in the longitudinal direction, i.e., in the direction of movement, and transverse thereto. The cutting device 9 cuts the longitudinal sides off cleanly to form defined ends of the cellular glass sheets to be generated, while the cutting device 10 transverse to the direction in which the cellular glass web is moving cuts individual cellular glass sheets 12 from the web, which are stacked by an automatic stacker 11 on a pallet 13 so as to then be transported away.

### DISCLOSURE OF THE INVENTION

### Object of the Invention

Although the apparatus and method for producing cellular glass sheets, such as are described in DE 10 2004 040 307 A1, facilitate good results, it is an object of the present invention to provide an improvement of the method and the apparatus to the extent that high-quality cellular glass sheets can be made reliably at the lowest possible outlay.

### Technical Solution

This object is achieved by a method having the characteristics of claim 3, comprising a cutting apparatus having the characteristics of claim 1 and a cellular-glass cooling section having the characteristics of claim 10. Advantageous embodiments are the subject of the dependent claims. The technical solution especially further comprises a combination of the independent claims and of their dependent claims among each other.

The invention proceeds from the recognition that there are several advantages to be gained over the prior art of the aforementioned DE 10 2004 040 307 A1 by transposing the cutting process for cutting the cellular glass web into individual sheets into the cellulating and/or cooling furnace. On the one hand, cutting resistance decreases as a result, and simpler, cheaper and easier-to-use cutting tools can be employed. In addition, the cutting operation itself can be performed more easily. Moreover, dividing the cellular glass web into individual segments inside the furnace facilitates simpler and more reliable cooling of the cellular glass sheets, so that the risk of stress cracks can be lowered.

The cutting operation for cutting the cellular glass web transverse to the conveying direction can especially take place while the cellular glass web is being conveyed, with the corresponding cutting tool capable of moving transversely to the cutting direction, i.e. in the direction in which the cellular glass is moving, during the cutting operation.

The cutting tool itself can be configured such that, for the purpose of the cutting operation, it is moved through the cellular glass web. Especially, the cutting tool can cut through the cellular glass web by moving through it just once, with the cutting tool itself otherwise executing no further movement or executing a further, superimposed cutting movement, such as the rotation of a cutting disc, or the reciprocating motion of a saw blade. A single through-passage by an otherwise rigid cutting tool is preferred because it is the easiest to implement, e.g. the drawing through of a cutting blade with a cutting edge.

The cellular glass web can be cut especially at that point where the cellular glass web has already formed a dimensionally stable outer shell during cooling yet still has a viscous core, so as to especially allow easy cutting with a simply held cutting tool.

In particular, the core of the cellular glass web during cutting can have a viscosity in the range 10⁴ to 10¹⁰ mPa s.

The surface temperature of the cellular glass web in the furnace during cutting can in particular be in the temperature range of 450° C. to 550° C., because that is where the cellular glass web has the optimum consistency.

For the purpose of cutting the cellular glass web, a cutting apparatus is used which can find general application for continuously moving objects that are to be cut transversely to the direction of movement. Correspondingly, independently of the method for the continuous production of cellular glass sheets or of a corresponding apparatus, a claim is also made for a cutting apparatus comprising an elongated holder having a cutting tool at one end of its longitudinal axis, said cutting tool being moved through the object to be cut for the purpose of cutting it. Accordingly, the holder has a movement device which enables the holder and/or the cutting tool to move back and forth along the longitudinal axis of the holder and enables movement through the object to be cut.

As the cutting direction is transverse to the direction of movement of the object to be cut, the direction of movement of the holder and/or a cutting tool arranged at it is also transverse to the direction of movement of the object to be cut. The movement of the cutting tool or of the holder transverse to the direction of movement of the object to be cut can then be regarded as a first movement of the cutting tool, which, in the simplest case, is the only movement of the cutting tool. However, the cutting tool itself can execute a second movement, superimposed on the first, with which the actual cutting operation is executed during movement through the object to be cut. For example, the cutting tool may be a cutting blade, which executes a rotary movement by way of second movement. Alternatively, the cutting tool may be a saw or a saw blade, which effects material separation of the object to be cut by means of a linear reciprocating movement. In the simplest case, however, the cutting tool can be a cutting blade with a cutting edge, said blade being rigidly disposed at the holder or at least not executing an additional movement to the first movement through the object to be cut, i.e. executing just one movement along the holder or with the holder through the object to be cut.

To compensate for the conveying movement of the object to be cut which occurs transversely to the cutting direction, the invention provides a compensation apparatus, which affords the cutting tool limited movement with the object to be cut, i.e. a third movement transverse to the cutting direction and any possible sawing movement. To this end, pivoting of the cutting tool by a corresponding joint or an elastic deformation of the cutting device and especially of the holder in the conveying direction is employed.

Since, according to the invention, the cellular glass web has not yet completely cooled to room temperature and thus solidified while it is being cut in the furnace, a cutting tool of correspondingly simple design, such as a cutting blade, can be used. Thus, it is sufficient, e.g., to manufacture the cutting blade from a correspondingly suitable steel or high-temperature material, without the need for elaborately designed materials of the kind used, e.g., for cutting solidified glass, such as diamond tools, etc.

### BRIEF DESCRIPTION OF THE FIGURES

Further advantages, labelling, characteristics of the present invention are apparent from the following detailed description of an embodiment. The accompanying drawings show in purely schematic form in

FIG. 1 a lateral cross-sectional view of an inventive cellular-glass cooling section;

FIG. 2 a detailed view of one embodiment of a cutting apparatus for the cellular-glass cooling section from FIG. 1;

FIG. 3 a detailed view of another embodiment of a cutting apparatus for the cellular-glass cooling section from FIG. 1, and in

FIG. 4 a lateral cross-sectional view through a cellular-glass cooling section according to the prior art.

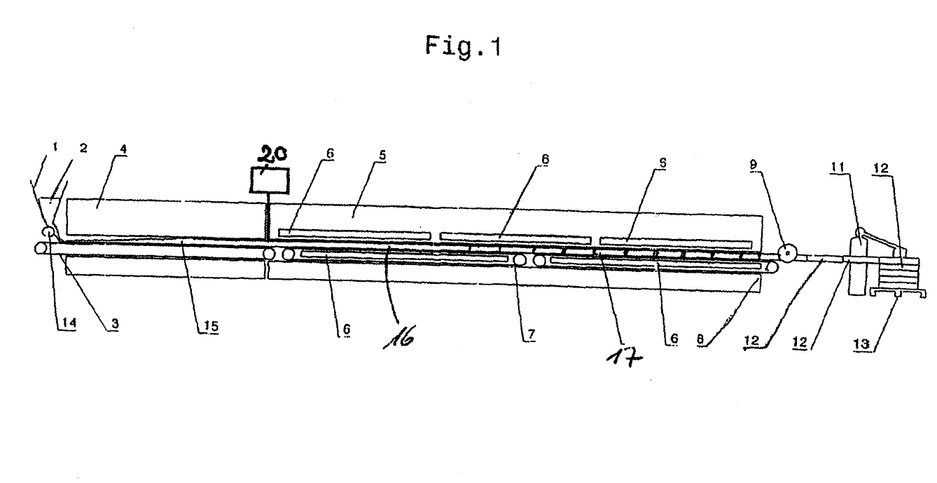

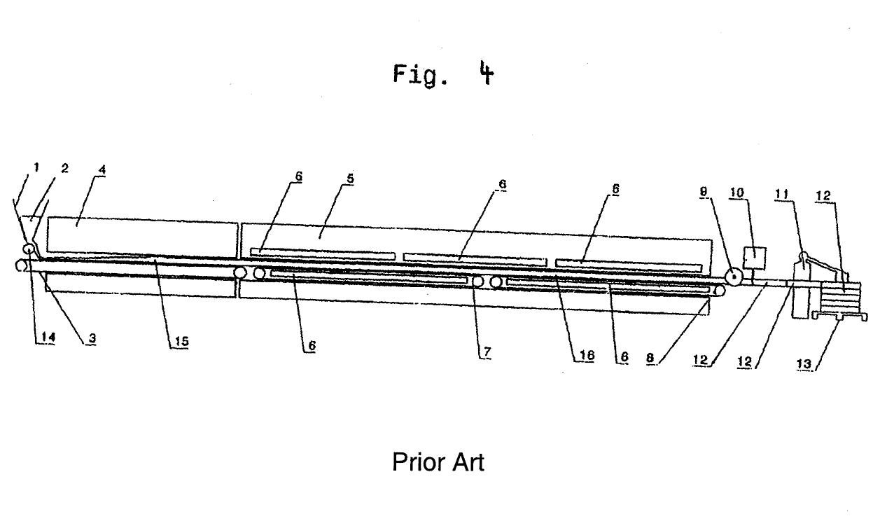

The left half of FIG. 1 shows a funnel-shaped feeder 1, with which the mixture 2 comprising blowing agent and cullet can be fed onto an endless transport conveyor 3 in a uniform manner via a feed roller 14. This gives rise to a bed 15 on the endless conveyor belt 3, said bed being moved by the endless conveyor belt 3 through the cellulating furnace 4 at a defined speed. In the cellulating furnace 4 are provided heaters, not shown, which raise the mixture 2 or the bed 15 to a corresponding temperature of about 600° C. to 950° C., especially about 800° C. to 850° C. This triggers the cellulation process, as a result of which a continuous cellular glass web 16 forms, which is then transferred directly into the cooling furnace 5 in a continuous manner.

In the cooling furnace 5 are provided corresponding conveyor devices 7 and 8, on which the cellular glass web 16 is further conveyed. Of course, several cooling furnaces or segments having a plurality of transport conveyor devices connected in series or a single cooling furnace with one or more segments with a single transport conveyor device can be provided.

In cooling furnace 5, in turn, are provided heating devices and/or cooling systems 6, which can be provided both above and beneath the cellular glass web 16. Additionally, heating and/or cooling devices can be provided at the sides of the cellular glass web (not shown) too, with all suitable heating devices and/or cooling systems, such as gas burners, electric heaters or blowers and the like capable of being provided.

By virtue of the uniform, slow and defined cooling of the cellular glass web 16 in the cooling furnace 5, internal stresses due to cooling are avoided and a continuous, long, cellular glass sheet is formed whose width corresponds to the conveyor device 3 or conveyor devices 7 and 8, which can be in the range of 1 to 2 m, preferably 1.40 m to 1.60 m. However, larger widths up to 4 m are conceivable.

Arranged at the end of the cellulating furnace 4 or at the transition to the cooling furnace 5 (as shown in FIG. 1) or at the beginning of the cooling furnace 5 is a cutting device 20, with which the cellular glass web 16 is divided into individual segments 17. The cutting apparatus 20 is arranged such that, at the point where the cutting apparatus 20 divides the cellular glass web 16 into corresponding segments, the cellular glass web already has a dimensionally stable outer shell yet still has a viscous core, so that it can be easily cut, e.g. with a simple cutting blade.

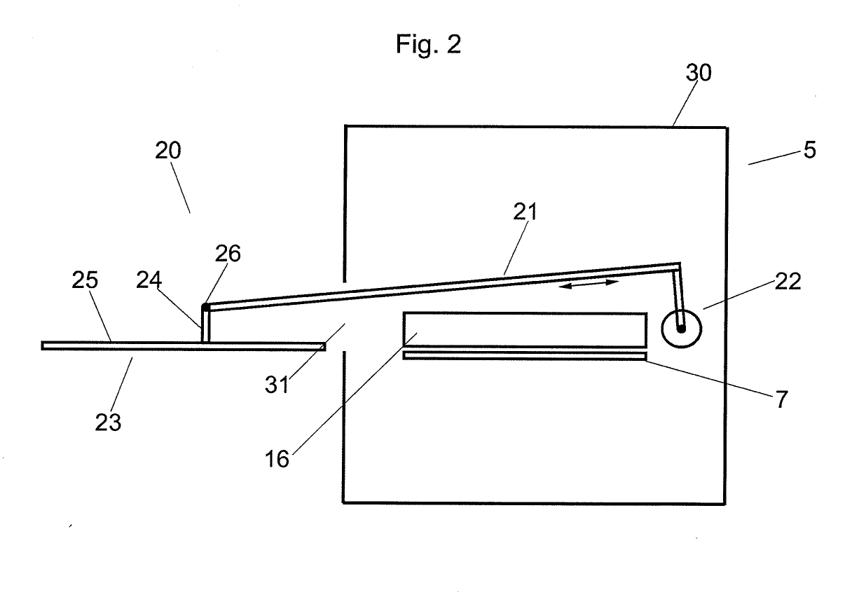

An embodiment of a corresponding cutting apparatus, as shown in the apparatus for producing cellular glass sheets in FIG. 1, is shown in FIG. 2. FIG. 2 in this case represents a cross-section through the cooling furnace 5 with its respective housing 30, wherein, in the cutting plane, an opening 31 is provided in the housing 30, so that the cutting apparatus can be located partly outside and partly inside the furnace and, accordingly, can be moved into and out of the furnace.

The cutting device 20 comprises an elongated holder 21, which at one end in the longitudinal direction comprises a cutting tool 22 in the form of a rotating cutting disc. Instead of the rotating cutting disc, as shown in FIG. 2, other cutting tools can be provided, such as a vertically reciprocating saw, whose direction of movement is transverse to the longitudinal direction of the holder 21, or a stationary cutting blade, which is also arranged transversely to the longitudinal extension of the holder 21 in the manner of the mounting bar of the cutting wheel 22, and has a cutting edge facing the holder 21, so that, a movement of the holder 21 along its longitudinal direction, would draw the cutting blade through the cellular glass web 16 and would divide the cellular glass web into corresponding segments.

As already mentioned, the holder 21 can be moved back and forth in the direction of its longitudinal extension as indicated by the double-headed arrow, so that the cutting tool 22 is moved through the cellular glass web 16. Alternatively, the cutting tool 22 alone can move back and forth along the holder 21 as indicated by the double-headed arrow.

In the illustrated embodiment, the holder 21 is moved into the furnace and then out again, with the cutting tool dividing the cellular glass web 16 into segments either upon entering or leaving the furnace. In the cutting-blade variant described above, whose cutting edge faces the holder, the cutting operation would take place upon leaving the furnace. Although a single passage through the cellular glass web is enough to effect separation of same, a cutting or separating function by the holder or the cutting tool during both entering and leaving is also conceivable.

In the embodiment shown, that end of the holder 21 in its longitudinal extension which is opposite the cutting tool is provided with a carriage 24, which is guided in a guide rail 25, and can be moved back and forth in the rail 25 via a drive (not shown), such as a chain or belt drive of an electric motor, such that the cutting tool 22 can be moved into and out of the furnace, thereby cutting through the cellular glass web. Instead of the movement device 23 formed by the rail 25, the movable carriage 24 and the drive, not shown, all other suitable types of movement devices for the holder and/or the cutting tool 22 can be used.

In order that compensation may be provided during the cutting operation for the movement of the cellular glass web 16 along the conveying section, the upper drum 7 of an endless conveyor belt of which is shown in FIG. 2, the cutting apparatus has a compensation device, which is realized, e.g. by an articulated joint 26, which permits the holder 21 to rotate in a direction perpendicular to the plane of FIG. 2 with respect to the carriage 24.

In addition, the joint 26 can facilitate pivoting of the holder about a rotary axis parallel to the conveying direction of the cellular glass, such that the cutting tool, either when entering or leaving the furnace, can be raised out of the plane of the cellular glass web 16 or, generally, the cutting tool 22 can be brought out of engagement with the cellular glass web 16.

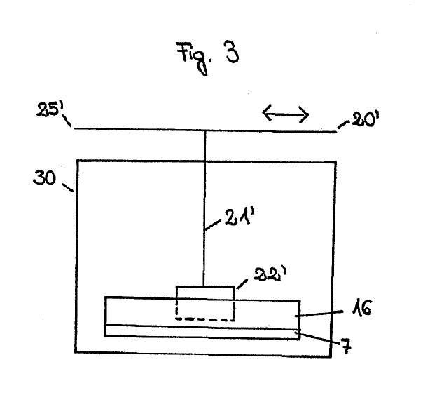

FIG. 3 shows a further embodiment of a cutting device 20′, in which a stationary cutting blade 22′ is provided at a holder 21′, which can be moved along a rail 25′ transversely to the conveying direction of the cellular glass web 16 on the upper drum 7 of the conveyor device. Here, too, the holder of the cutting device 20′ is introduced through an opening, e.g., a corresponding gap in the housing 30 of the furnace.

After separating the cellular glass web 16 into individual segments 17, these, as shown in FIG. 1, are transported further through the cooling furnace 5 until they have been cooled sufficiently slowly such that the individual cellular glass segments leave the cooling furnace 5 as stress-free-cooled, cellular glass sheets.

At the end of cooling furnace 5, once the cellular glass segments 17 have cooled to approx. room temperature, a further cutting device 9 is provided to cleanly cut the edges of the cellular glass sheets 17 in the conveying direction of the cellular glass.

Accordingly, cellular glass sheets 12 emerge from the system, such that they can be stacked by an appropriate automatic lifting system 11 directly into appropriate shipping units or transport units 13.

As has been shown from the description of the embodiment, different cutting devices can be used to separate the cellular glass web 16 into cellular glass segments 17, with preference being accorded to the claimed cutting device. However, cutting devices other than those claimed can be used in the corresponding method and the corresponding apparatus. In the same way, it will be understood that the inventive method for the production of cellular glass sheets can be also carried out with systems and apparatuses other than the apparatus which has been described and claimed.

In addition, it will be clearly understood by a person skilled in the art that the present invention is not limited to the described embodiment, but rather that modifications are possible in the manner that individual characteristics are not realized, or other types of combinations of described characteristics are used, as long as the scope of protection of the appended claims is retained. In particular, all possible combinations of the presented individual characteristics are disclosed with the present description.

1. Cutting apparatus for cutting a continuously moving object transversely to the direction of movement comprising a cutting tool and an extended holder, at the end of the longitudinal axis of which there is amounted the cutting tool, wherein the holder comprises a movement device, with which at least one of the holder and of the cutting tool can be moved along the longitudinal axis of the holder, and wherein the cutting apparatus comprises a compensation device with which the movement transverse to the longitudinal axis of the holder is compensated during cutting, and wherein the compensation apparatus is configured such that the holder can be pivoted and/or elastically deformed transversely to the longitudinal axis of the holder.

2. Cutting apparatus in accordance with claim 1,
wherein the cutting tool is a blade whose cutting edge is arranged transversely to the holder, a rotating cutting disc or a saw which reciprocates transversely to the holder.

3. Method for the continuous production of cellular glass sheets, wherein the cellular glass is expanded from at least one glass raw material and at least one blowing agent in a cellulating furnace to yield a cellular glass web and is then continuously cooled in a cooling furnace, wherein the cellular glass web is transported on a continuous conveyor system through the furnace(s) during foaming and cooling, wherein the cellular glass web in the hot state is cut in a or between two furnaces by a cutting apparatus comprising a cutting tool and an extended holder, at the end of the longitudinal axis of which there is mounted the cutting tool, wherein the holder comprises a movement device, with which at least one of the holder and of the cutting tool can be moved along the longitudinal axis of the holder, and wherein the cutting apparatus comprises a compensation device with which the movement transverse to the longitudinal axis of the holder is compensated during cutting, and wherein the compensation apparatus is configured such that the holder can be pivoted and/or elastically deformed transversely to the longitudinal axis of the holder.

4. Method in accordance with claim 3,
wherein the cellular glass web is cut during the transport movement through the furnace.

5. Method in accordance with claim 3,
wherein the cutting tool moves with the cellular glass web transversely to the cutting direction.

6. Method in accordance with claim 3,
wherein the cutting apparatus comprises a cutting tool, which is moved through the cellular glass web for the purpose of cutting the cellular glass web transversely to the direction in which the cellular glass web is being transported.

7. Method in accordance with claim 3,
wherein the cellular glass web is cut at a location in the furnace or between two furnaces, where the cellular glass web has a dimensionally stable outer shell and a viscous core, especially at the end of the cellulating furnace or at the beginning of a cooling furnace or between cellulating furnace and cooling furnace.

8. Method in accordance with claim 3,
wherein the core of the cellular glass web during cutting can have a viscosity in the range 10⁴ to 10¹⁰ mPa s.

9. Method in accordance with claim 3,
wherein the cellular glass web is cut at a surface temperature of the cellular glass web in the furnace of 450° C. to 550° C.

10. Cellular-glass cooling section with one or more furnaces in which a cellular glass web is continuously moved on a conveying section in order that the and slowly cooled,
wherein the cellular-glass cooling section comprises a cutting apparatus in a furnace or between two furnaces, with which the cellular glass web can be cut in the furnace transversely to the direction of movement, the cutting apparatus comprising a cutting tool and an extended holder, at the end of the longitudinal axis of which there is mounted the cutting tool, wherein the holder comprises a movement device, with which at least one of the holder and of the cutting tool can be moved along the longitudinal axis of the holder, and wherein the cutting apparatus comprises a compensation device with which the movement transverse to the longitudinal axis of the holder is compensated during cutting, and wherein the compensation apparatus is configured such that the holder can be pivoted and/or elastically deformed transversely to the longitudinal axis of the holder.

11. Cellular-glass cooling section in accordance with claim 10,
wherein the cutting tool is a blade whose cutting edge is arranged transversely to the holder, a rotating cutting disc or a saw which reciprocates transversely to the holder.

12. Method in accordance with claim 3,
wherein the cutting tool is a blade whose cutting edge is arranged transversely to the holder, a rotating cutting disc or a saw which reciprocates transversely to the holder.
